(19) United States
(12) Patent Application Publication
(10) Pub. No.: US 2026/0156521 A1
(43) Pub. Date: Jun. 4, 2026

(54) DEVICES AND METHODS FOR SERVICE DATA FLOW DISTRIBUTION FOR MULTI-CONNECTIVITY

(71) Applicant: HUAWEI TECHNOLOGIES CO., LTD., Shenzhen (CN)

(72) Inventors: Sripriya Srikant Adhatarao, Munich (DE); Zoran Despotovic, Munich (DE); Artur Hecker, Munich (DE)

(21) Appl. No.: 19/459,188

(22) Filed: Jan. 26, 2026

Related U.S. Application Data
(63) Continuation of application No. PCT/EP2023/070879, filed on Jul. 27, 2023.

(51) Int. Cl. H04W 28/02

(52) U.S. Cl. CPC H04W 28/0268

(57) ABSTRACT

A user equipment (UE) (110) for communication with a data network (150) is disclosed. The UE (110) communicates with the data network (150) via base station (120) providing access network and for each access network a plurality of data channels (118) for a plurality of Service Data Flows (SDFs). The UE (110) stores a data structure (160) containing mapping data, and implement a Service data flow Distribution Manager (SDM) (111a), the SDM (111a) assigns, based on the mapping data of the data structure (160), each of a plurality of uplink data packets to the plurality of data channels (118) of the access networks. The UE (110) further transmits each of the plurality of uplink data packets via the one or more assigned data channels (118) of the one or more access networks to the data network (150).

### CROSS-REFERENCE TO RELATED APPLICATIONS

This application is a continuation of International Application No. PCT/EP2023/070879, filed on Jul. 27, 2023, the disclosure of which is hereby incorporated by reference in its entirety.

### TECHNICAL FIELD

The present disclosure relates to wireless communications. More specifically, the present disclosure relates to devices and methods for distributing a plurality of Service Data Flows (also referred to as QoS flows) in a multi-connectivity scenario.

### BACKGROUND

The heterogeneity in radio access technologies (LTE, 5G New Radio (NR), 6G THz, NTN, Wi-Fi) and their communication infrastructure equipment's like the BS nodes, pose many challenges to enable seamless communication in a multi-connectivity scenario in mobile communication networks.

In the current 3GPP standards, there is no way to unify the various different access networks i.e., the data channels in and across access networks. During a PDU session establishment process, a QoS flow (herein also referred to as a Service Data Flow, SDF) is mapped to a single data channel provided by a dedicated access network node post configuration. The mapping of a QoS flow to a data channel remains fixed through ought the lifetime of a PDU session. Thus, packets from a QoS flow cannot be distributed on 2 or more data channels, even if the data channels were available (and capable of fulfilling the QoS) regardless, if the data channels belong to the same access network node or belong to other access nodes in the same access network or to access nodes in different access networks, possibly with even different technologies. The major drawbacks of such fixed assignment include in-efficient resource utilization, limited throughput, and latency.

### SUMMARY

It is an objective of the present disclosure to provide improved devices and methods for distributing a plurality of Service Data Flows (also referred to as QoS flows), especially in a multi-connectivity scenario.

The foregoing and other objectives are achieved by the subject matter of the independent claims. Further implementation forms are apparent from the dependent claims, the description and the figures.

According to a first aspect, a user equipment, UE, for communication with a data network is provided. The UE is configured to communicate with the data network via one or more base stations providing one or more access networks and for each access network a plurality of data channels for a plurality of Service Data Flows, SDFs (also referred to as QoS flows). Moreover, the UE is configured to store a data structure containing mapping data, for instance, in a memory of the UE, and to implement a Service data flow Distribution Manager, SDM, wherein the SDM is configured to assign, based on the mapping data of the data structure, each of a plurality of uplink data packets to one or more of the plurality of data channels of the one or more access networks. The UE is further configured to transmit each of the plurality of uplink data packets via the one or more assigned, i.e. selected data channels of the one or more access networks to the data network. Thus, the SDM allows distributing the packets in an SDF on all the available data channels of all connected networks based on the data structure containing the mapping data. The mapping data contained in the data structure, in turn, enables the SDM to distribute the packets in an SDF across the available data channels of connected networks based on the policies/rules provided by, for instance, a mobile network operator.

In a further possible implementation form, each uplink data packet of the plurality of uplink data packets comprises a SDF identifier and the SDM of the UE is configured to assign each of the plurality of uplink data packets to the one or more of the plurality of data channels of the one or more access networks, based on the mapping data of the data structure and the SDF identifier of the uplink data packet. This allows for an efficient mapping of the data packets to data channels based on the SDF identifier of the respective data packet and thereby improve the throughput and reduce the latency experienced by the UE and maximize the resource utilization of the network.

In a further possible implementation form, the data structure is a Service data flow Distribution Table, SDT, comprising the mapping data. This allows storing and accessing the mapping data in the SDT in an efficient manner.

In a further possible implementation form, the plurality of uplink data packets are part of a packet data unit, PDU, session. This allows for a seamless integration in an established communication structure of mobile networks.

In a further possible implementation form, the UE is configured to implement a protocol stack and to implement the SDM in a layer of the protocol stack above a Service Data Adaptation Protocol, SDAP, layer of the protocol stack and/or below an IP layer. This allows for an efficient implementation of the SDM in the UE protocol stack.

In a further possible implementation form, the UE is configured to receive the data structure with the mapping data from a control plane entity. This allows efficiently providing the data structure with the mapping data from an entity under the control of, for instance, a mobile network operator.

According to a second aspect a method for operating a user equipment, UE, for communication with a data network is provided. The method comprises the steps of:
communicating with the data network via one or more base stations providing one or more access networks and for each access network a plurality of data channels for transporting a plurality of Service Data Flows, SDFs;
implementing a Service data flow Distribution Manager, SDM, wherein the SDM is configured to assign, based on mapping data of a data structure stored in a memory of the UE, each of a plurality of uplink data packets to one or more of the plurality of data channels of the one or more access networks; and
transmitting each of the plurality of uplink data packets via the one or more assigned data channels of the one or more access networks to the data network.

The method according to the second aspect of the present disclosure can be performed by the UE according to the first aspect of the present disclosure. Thus, further features of the method according to the second aspect of the present disclosure result directly from the functionality of the UE according to the first aspect of the present disclosure as well as its different implementation forms described above and below.

According to a third aspect a base station for handling communication between a user equipment, UE, and a data network is provided. The base station is configured to communicate with the UE via a plurality of data channels provided by one or more access networks for transporting a plurality of Service Data Flows, SDFs. Moreover, the base station is configured to store a data structure with mapping data and implement a Service data flow Distribution Manager, SDM, wherein the SDM is configured to assign, based on the mapping data of the data structure, each of a plurality of downlink data packets to one or more of the plurality of data channels of the one or more access networks. The base station is further configured to transmit each of the plurality of downlink data packets via the one or more assigned data channels of the one or more access networks to the UE. Thus, the SDM allows distributing the packets in an SDF on all the available data channels of all connected networks based on the data structure containing the mapping data. The mapping data contained in the data structure, in turn, enables the SDM to distribute the packets in an SDF across the available data channels of connected networks based on the policies/rules provided by, for instance, a mobile network operator.

In a further possible implementation form, each downlink data packet of the plurality of downlink data packets comprises a SDF identifier and the SDM is configured to assign each of the plurality of downlink data packets to the one or more of the plurality of data channels of the one or more access networks, based on the mapping data of the data structure and the SDF identifier of the downlink data packet. This allows for an efficient mapping of the data packets to data channels based on the SDF identifier of the respective data packet and thereby improve the throughput and reduce the latency experienced by the UE and maximize the resource utilization of the network.

In a further possible implementation form, the data structure is a Service data flow Distribution Table, SDT, with the mapping data. This allows storing and accessing the mapping data in the SDT in an efficient manner.

In a further possible implementation form, the plurality of downlink data packets are part of a PDU session, i.e. packets of a PDU session. This allows for a seamless integration in an established communication structure of mobile networks.

In a further possible implementation form, the base station is configured to implement a protocol stack and to implement the SDM in a layer of the protocol stack above a Service Data Adaptation Protocol, SDAP, layer of the protocol stack and/or below an IP layer. This allows for an efficient implementation of the SDM in the protocol stack of the base station.

In a further possible implementation form, the base station is configured to receive the data structure with the mapping data from a control plane entity. This allows efficiently providing the data structure with the mapping data from an entity under the control of, for instance, a mobile network operator.

According to a fourth aspect a method of operating a base station for handling communication between a user equipment, UE, and a data network is provided. The method comprises the steps of:
communicating with the UE via a plurality of data channels provided by one or more access networks for transporting a plurality of Service Data Flows, SDFs;
implementing a Service data flow Distribution Manager, SDM, wherein the SDM is configured to assign, based on mapping data of a data structure stored in a memory of the base station, each of a plurality of downlink data packets to one or more of the plurality of data channels of the one or more access networks; and
transmitting each of the plurality of downlink data packets via the one or more assigned data channels of the one or more access networks to the UE.

The method according to the fourth aspect of the present disclosure can be performed by the base station according to the third aspect of the present disclosure. Thus, further features of the method according to the fourth aspect of the present disclosure result directly from the functionality of the base station according to the third aspect of the present disclosure as well as its different implementation forms described above and below.

According to a sixth aspect a network entity for handling communication between a user equipment, UE, and a data network is provided. The network entity is configured to communicate with the UE via a plurality of data channels provided by one or more access networks provided by one or more base stations for transporting a plurality of Service Data Flows, SDFs. Moreover, the network entity is configured to store a data structure with mapping data and to implement a Service data flow Distribution Manager, SDM, wherein the SDM is configured to assign, based on the mapping data of the data structure, each of a plurality of downlink data packets to one or more of the plurality of data channels of the one or more access networks. The network entity is further configured to transmit each of the plurality of downlink data packets via the one or more assigned data channels of the one or more access networks to the UE. Thus, the SDM allows distributing the packets in an SDF on all the available data channels of all connected networks based on the data structure containing the mapping data. The mapping data contained in the data structure, in turn, enables the SDM to distribute the packets in an SDF across the available data channels of connected networks based on the policies/rules provided by, for instance, a mobile network operator.

In a further possible implementation form, each downlink data packet of the plurality of downlink data packets comprises a SDF identifier and the SDM is configured to assign each of the plurality of downlink data packets to the one or more of the plurality of data channels of the one or more access networks, based on the mapping data of the data structure and the SDF identifier of the downlink data packet. This allows for an efficient mapping of the data packets to data channels based on the SDF identifier of the respective data packet and thereby improve the throughput and reduce the latency experienced by the UE and maximize the resource utilization of the network.

In a further possible implementation form, the data structure is a Service data flow Distribution Table, SDT, with the mapping data. This allows storing and accessing the mapping data in the SDT in an efficient manner.

In a further possible implementation form, the plurality of downlink data packets are part of a PDU session. This allows for a seamless integration in an established communication structure of mobile networks.

In a further possible implementation form, the network entity is configured to implement a protocol stack and to implement the SDM in a layer of the protocol stack above a Service Data Adaptation Protocol, SDAP, layer of the protocol stack and/or below an IP layer. This allows for an efficient implementation of the SDM in the protocol stack of the network entity.

In a further possible implementation form, the network entity is configured to receive the data structure with the mapping data from a control plane entity. This allows efficiently providing the data structure with the mapping data from an entity under the control of, for instance, a mobile network operator.

According to a sixth aspect a method for operating a network entity for handling communication between a user equipment, UE, and a data network is provided. The method comprises the steps of:
communicating with the UE via a plurality of data channels provided by one or more access networks provided by one or more base stations for transporting a plurality of Service Data Flows, SDFs;
implementing a Service data flow Distribution Manager, SDM, wherein the SDM is configured to assign, based on mapping data of a data structure stored in a memory of the network entity, each of a plurality of downlink data packets to one or more of the plurality of data channels of the one or more access networks; and
transmitting each of the plurality of downlink data packets via the one or more assigned data channels of the one or more access networks to the UE.

The method according to the sixth aspect of the present disclosure can be performed by the network entity according to the fifth aspect of the present disclosure. Thus, further features of the method according to the sixth aspect of the present disclosure result directly from the functionality of the network entity according to the fifth aspect of the present disclosure as well as its different implementation forms described above and below.

According to a seventh aspect, a computer program product is provided, comprising a computer-readable storage medium for storing a program code which causes a computer or a processor to perform the method according to the second aspect, the method according to the fourth aspect, or the method according to the sixth aspect, when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows a schematic diagram illustrating a mobile telecommunication system comprising a UE, a base station, and a network entity according to an embodiment making use of a mapping data structure for establishing multi-connectivity communication with a data network;

FIG. 2 is a schematic diagram illustrating an example for different entities and processing steps for generating the mapping data structure used by the UE, the base station, and the network entity according to an example;

FIG. 3 is a flow diagram illustrating processing steps implement by a UE according to an example for UL multi-connectivity data transmission based on the mapping data structure;

FIG. 4 is a flow diagram illustrating processing steps implement by a network entity according to an example for UL multi-connectivity data transmission based on the mapping data structure;

FIG. 5 is a flow diagram illustrating processing steps implement by a network entity according to an example for DL multi-connectivity data transmission based on the mapping data structure;

FIG. 6 is a flow diagram illustrating processing steps implement by a base station according to an example for DL multi-connectivity data transmission based on the mapping data structure;

FIG. 7 is a signaling diagram illustrating interactions between the UE, the base station, and the network entity according to an example with further network entities for UL multi-connectivity data packet transmission;

FIG. 8 is a signaling diagram illustrating interactions between the UE, the base station, and the network entity according to an example with further network entities for DL multi-connectivity data packet transmission;

FIGS. 9 to 11 show schematic diagrams illustrating different variants of the mobile telecommunication system of FIG. 1 comprising a UE, a base station, and a network entity according to an example making use of a mapping data structure for establishing multi-connectivity communication with a data network;

FIG. 12 is a flow diagram illustrating a method for operating a UE according to an example;

FIG. 13 is a flow diagram illustrating a method for operating a base station according to an example; and

FIG. 14 is a flow diagram illustrating a method for operating a network entity according to an example.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. Moreover, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

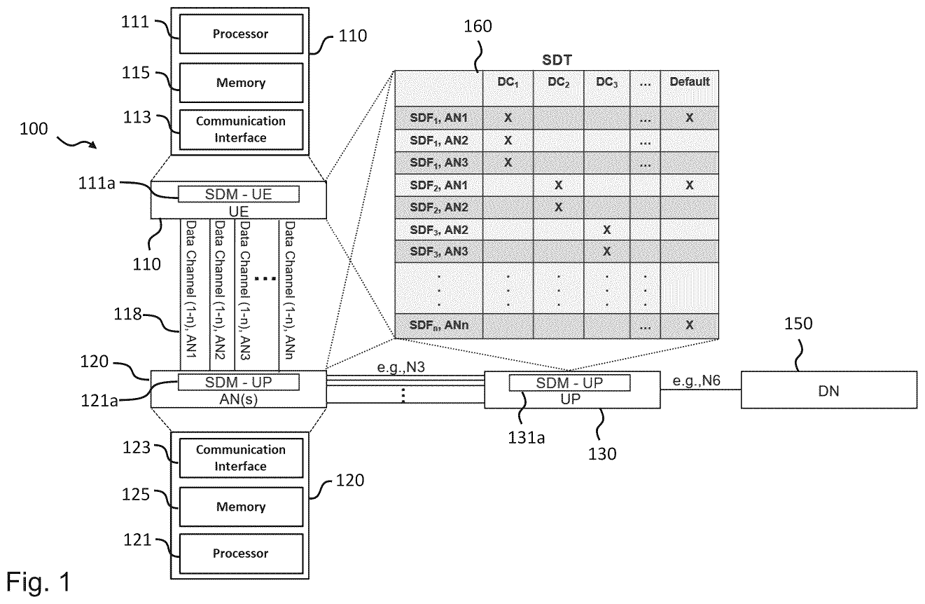

FIG. 1 shows a schematic diagram illustrating a mobile telecommunication system 100 comprising at least one user equipment, UE, 110 according to an embodiment, at least one base station 120 according to an embodiment, and a network entity 130, for instance, in the form of a UPF 130, according to an embodiment. In an embodiment, the mobile telecommunication system 100 is a 3rd Generation Partnership Project (3GPP) mobile telecommunication system 100. As will be described in more detail below, the UE 110, the base station 120, and the network entity 130 are configured to make use of a mapping data structure 160, in particular a mapping table 160 (herein also referred to as Service data flow Distribution Table, SDT, 160) for establishing multi-connectivity communication between the UE 110 and a data network 150, such as the Internet 150.

As illustrated in FIG. 1, the UE 110 may comprise a processing circuitry, e.g. one or more processors 111 and a communication interface 113. The processing circuitry 111 may be implemented in hardware and/or software. The hardware may comprise digital circuitry, or both analog and digital circuitry. Digital circuitry may comprise components such as application-specific integrated circuits (ASICs), field-programmable gate arrays (FPGAs), digital signal processors (DSPs), or one or more general-purpose processors. Moreover, the UE 110 may comprise a memory 115 configured to store the SDT 160 as well as executable program code which, when executed by the processing circuitry 111, causes the UE 110 to perform the functions and operations described herein.

Likewise, the base station 120 may comprise a processing circuitry, e.g. one or more processors 121 and a communication interface 123. The processing circuitry 121 may be implemented in hardware and/or software. The hardware may comprise digital circuitry, or both analog and digital circuitry. Digital circuitry may comprise components such as application-specific integrated circuits (ASICs), field-programmable gate arrays (FPGAs), digital signal processors (DSPs), or one or more general-purpose processors. Moreover, the base station 120 may comprise a memory 124 configured to store the SDT 160 as well as executable program code which, when executed by the processing circuitry 121, causes the base station 120 to perform the functions and operations described herein.

As illustrated in FIG. 1, the UE 110 is configured to communicate with the base station(s) 120 via a plurality of data channels 118 of one or more access networks or access technologies. As will be appreciated, the block 120 in FIG. 1 represents one or more base stations or access network, AN, nodes or short “AN(s)” (also illustrated by the plurality of data channels 118, which illustrate connections from the UE 110 to the AN nodes AN1-ANn). Thus, if in the following description the block 120 is referred to as base station 120, this has to be understood as one or more base stations 120 or one base station 120 of a plurality of base stations. The base station 120 may communicate with the network entity 130, for instance, via a N3 interface, while the network entity 130, in turn, communicates with the data network 150, for instance, via a N6 interface.

Before describing more detailed embodiments of the UE 110, the base station 120, and the network entity 130 for establishing multi-connectivity communication between the UE 110 and the data network 150, in the following some technical background as well as terminology will be introduced making use of one or more of the following abbreviations:
3rd Generation Partnership Project 3GPP
Access and Mobility Management Function AMF
Access Network AN
Access Traffic Steering, Switching & Splitting ATSSS
Artificial Reality AR
Base Station BS
Buffering Action Rules BAR
Control Plane CP
Core Network CN
Data Network DN
Down Link DL
Dual Connectivity DC
Edge Application Server EAS
enhanced Mobile BroadBand eMBB
Forwarding Action Rules FAR
Geostationary Earth Orbit GEO
Guaranteed Bit Rate GBR
High Altitude Platform Stations HAPS
Internet Protocol version 4 IPv4
Internet Protocol version 6 IPv6
Long-Term Evolution LTE
Low Earth Orbit LEO
massive Machine Type Communications mMTC
Master Cell Group MCG
Master Node MN
Media Access Control MAC
Mobile Network Operator MNO
Multi Access MA
Multi Connectivity MC
Multipath Transmission Control Protocol MPTCP
Multi-Radio Dual Connectivity MR-DC
Network Data Analytics Function NWDAF
Network Exposure Function NEF
Network Function NF
New Radio NR
Next Generation Application Protocol NG-AP
Non-Access Stratum NAS
Non-Terrestrial Network NTN
Operating System OS
Packet Detection Rules PDR
Packet Forwarding Control Protocol PFCP
PDU Session Anchor PSA
Physical Layer PHY
Policy and Charging Control PCC
Policy Control Function PCF
Protocol Data Convergence Protocol PDCP
Protocol Data Unit PDU
Quality of Service QoS
Quality of Service Enforcement Rules QER
Quality of Service Flow Identifier QFI/QI
Radio Access Network RAN
Radio Link Control RLC
Radio Resource Control RRC
Reinforcement Learning RL
Secondary Cell Group SCG
Secondary Node SN
Service Based Architecture SBA
Service Based Interface SBI
Service Data Adaptation Protocol SDAP
Service Data Flow SDF
Service data flow Distribution Manager SDM
Service data flow Distribution Table SDT
Session Management Function SMF
Single Network Slice Selection Assistance information S-NSSAI
State of The Art SoTA
Terrestrial Network TN
Timing Advance TA
Traffic Flow Template TFT
ultra-Reliable Low Latency Communications uRLLC
Unified Data Management UDM
Up Link UL
Uplink Classifier UL CL
Usage Reporting Rules URR
User Equipment UE
User Plane UP
User Plane Function UPF
Virtual Reality VR
Wireless Fidelity Wi-Fi

As already described above, the mobile telecommunication system 100 shown in FIG. 1 may be a 3GPP mobile telecommunication system 100. In such a 3^{rd} Generation Partnership Project (3GPP) mobile telecommunication system 100, a cellular network comprises of a Radio Access Network (RAN) and a Core Network (CN). The RAN manages the radio frequency spectrum and provides wireless connectivity to the mobile end-devices, such as the UE 110. While the CN performs the control and management operations and provides connectivity to the UE 110 with the external Data Network (DN) 150, like the Internet 150. The RAN is realized with a group of strategically located geographically dispersed Base Stations (BS), such as the base station 120 of FIG. 1, that are connected to the CN via a backhaul network. For each UE 110, the BS 120 creates a wireless channel to provide the bearer service (data channel) when the UE 110 powers up, resumes to ACTIVE mode from IDLE mode or during handover when the UE 110 enters the coverage area of the BS 120. The BS 120 is also responsible for connecting the UE 110 to the CN's Control Plane (CP) and forwarding the signaling traffic between the UE 110 and CN CP entities to enable authentication, registration, Protocol Data Unit (PDU) session establishment and mobility. During PDU session establishment, to enable data transmission, the BS 120 creates one or more tunnels for the UE 110 between the BS 120 and the CN User Plane (UP) to transmit the UE's UP traffic on these tunnels. The bearer is a data transmission channel between the UE 110 and the BS 120 in 5G (and between the UE 110, BS 120 and UPF 130 in 4G Long-Term Evolution (LTE)) wherein, each bearer is associated with a specific set of Quality of Service (QoS) properties. The first bearer established during a PDU session establishment process is called the default bearer. The default bearer has basic QoS properties and remains active throughout the lifetime of a PDU session. While additional bearers (called the dedicated bearers) are established by the BS 120 on demand during an ongoing PDU session to satisfy any other specific QoS requirements that may be requested by the UE 110. Multiple bearers can be established to provide different QoS treatments to traffic generating from the UE 110 wherein, each QoS flow is transported on a dedicated bearer that corresponds to the QoS properties required by the traffic. In contrast to the default bearer, the dedicated bearers are usually deactivated by the BS 120 when they are no longer needed.

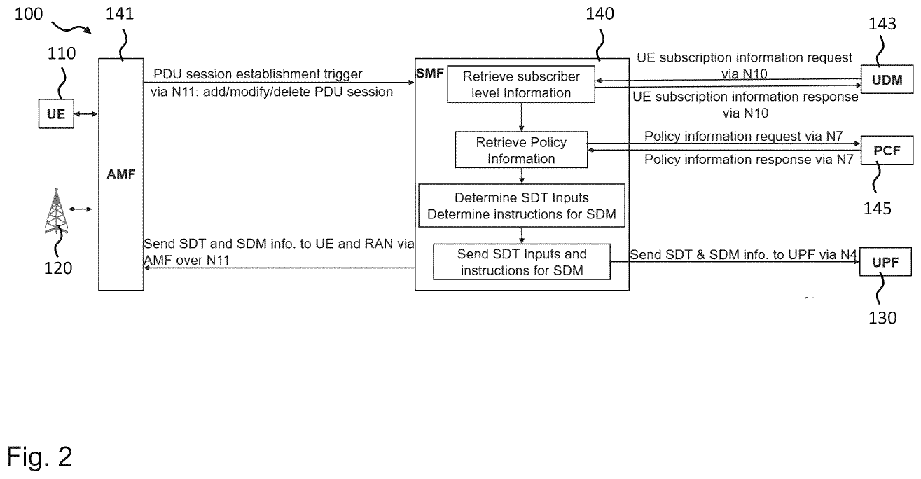

In a 3GPP 5G system, such as mobile telecommunication system 100 of FIG. 1 according to an embodiment, QoS flow is the lowest level of granularity used to classify the data packets for transmission and where the policy and charging are enforced. Before any data transmission can begin, generally a PDU session must be in place for the UE 110. Therefore, after successful authentication and registration, the UE 110 may initiate a PDU session establishment process by sending a PDU session establishment request to a Session Management Function (SMF) 140 (illustrated in FIG. 2) via an Access and Mobility Management Function (AMF) 141 (also illustrated in FIG. 2). The SMF 140 establishes the PDU session for the UE 110 and sends a PDU session establishment accept message back to the UE 110, if no exceptional conditions are met. Otherwise, the SMF 140 rejects the request to establish a PDU session from the UE 110.

Conventionally, during the PDU session establishment process, an IP address is assigned to the UE 110 and QoS flow(s) are established for transmitting data between a Data Network (DN) and one or more application(s) running on an UE. The SMF binds the Policy and Charging Control (PCC) rules retrieved from the Policy Control Function (PCF) to QoS Flows and assigns the corresponding QoS Flow Identifier (QFIs/QIs) to each flow and further derives the QoS profile based on the QoS and service requirements. The SMF then provides the QoS profile and QFIs to the base station, which optionally may also be used to map the DL QoS flows to the respective data channel. The base station configures the UE to map the UL QoS flows to the corresponding data channels. The SMF provides the QoS rules to the UE, which are used to map the UL packets to the QoS flows followed by the application of the corresponding QIs. Once a PDU session is established in the Non-Access Stratum (NAS), the Up Link (UL) data packets from the applications running in the UE are mapped to the QoS flows based on the QoS rules of the operator (packet filters) and the packets are marked with QoS flow markings, i.e., QI, which is then used to group QoS flows and map them to the Access Network (AN) resources, i.e., data channels. Conventionally, there are broadly two types of QoS Flows, Guaranteed Bit Rate (GBR) and non-Guaranteed Bit Rate (non-GBR). In principle, the traffic with the same QFI receive the same treatment on the mobile network. Each UL data packet from the UE is transmitted over the data channel that satisfies the QoS properties required by the PDU session to UPF, which then forwards the packets to the DN. Similarly, the DL data packets arriving from the DN for the UE are received by the UPF, which uses Protocol Detection Rules (PDR) and QoS profile configured by SMF to classify the packets into QoS flows and forward them to the AN with an indication of QI for the QoS flow. The AN map the QoS flows to the corresponding data channel using the QI and forwards the DL packets to UE over the respective data channel.

For each PDU session, the 5GC allows up to 64 QoS Flows, and a unique set of radio data channels, i.e., a radio data channel can only belong to a single PDU session. A maximum of 16 radio data channels are allowed for each PDU session, wherein each data channel carries 1 or more QoS Flows, while the base station decides which QoS Flows are transported on which data channel. A UE in 5G can have up to 16 PDU sessions and, therefore, 1024 QoS Flows. Every QoS Flow is associated with a profile describing its parameters and characteristics like GBR or non-GBR. Multiple IP flows can be mapped to the same QoS Flow. Service Data Adaptation Protocol (SDAP), a Layer2 sub layer in the Radio Protocol Stack in the UE and base station maps the QoS Flows to the respective radio data channels using the Traffic Flow Template (TFT) containing the fields {Source IP Address, Destination IP Address, Source Port No, Destination Port No, Protocol ID}. The UE and the UPF use the packet filter set to classify packets into QoS Flows. The IP packet filter set contains the fields {Source IP Address, Destination IP Address, Source Port No, Destination Port No, Protocol ID of the protocol above the IP layer/next header type, Type of Service (Internet Protocol version 4 (IPv4)) or Traffic Class (Internet Protocol version 6 (IPv6)) and Mask, Flow Label (IPv6), Security Parameter Index, and packet filter direction} while the Ethernet packet filter set contains the fields {Source MAC Address, Destination MAC Address, Ethernet type, VID and PCP/DEI fields for Customer-VLAN tag (C-TAG) and/or Service-VLAN tag (S-TAG, VID), IP packet filter set, packet filter direction}.

The common components of the 3GPP 5G protocol stack for CP and UP include the Physical layer (PHY) (layer 1), the Media Access Control (MAC), Radio Link Control (RLC) and Packet Data Convergence Protocol (PDCP) (layer 2). The components above PDCP in layer 2 are different in CP and UP. In the UP stack, the SDAP (layer 2) is situated above the PDCP, whereas in CP stack, Radio Resource Control (RRC) and NAS (Application Layer) are situated above the PDCP. SDAP is responsible for mapping the QoS Flows originating from Applications (layer 1) to the corresponding radio data channels. SDAP maps the QoS Flows to data channel based on the rules configured by RRC. The NAS layer connects to the AMF in the CN CP. A single NAS signaling connection is used for each access that the UE is connected to over the N1 interface terminating in AMF. This connection is used for connection and registration management, and for conveying session management related messages and procedures. The Next Generation Application Protocol (NG-AP) layer sits on top of the CP stack in 5G AN and AMF and it is the application layer protocol used between the 5G AN and AMF and SMF (relayed transparently by AMF from AN to SMF).

The RRC configures policy and related aspects including the decisions on if a packet should be processed in a BS or forwarded to another BS. PDCP performs many operations including, ciphering, integrity, IP header compression/decompression, and early forwarding decisions (e.g., send the DL packet to UE or to another BS). RLC performs segmentation and reassembly, reliable segment transmission/receiving, MAC buffers the segments, multiplex/demultiplex segments, makes decision for real-time scheduling and late forwarding. PHY layer handles coding and modulations and transmissions. The size of the segment can range anywhere from a few bytes to an entire IP packet. The NAS protocol can be broadly split into NAS-SM and NAS-MM. NAS-SM provides support for handling Session Management between UE and SMF (transparently via AMF). It also supports establishing/modification/release of the UP PDU sessions and hence, the NAS-SM messages include the PDU session ID. NAS-MM supports the ciphering, integration protection, registration management, connection management and activation/deactivation of UP connections.

In the current 3GPP standards described above, there is no way to unify the various different access networks i.e., the data channels in and across access networks. As described above, during a PDU session establishment process, a QoS flow is mapped to a single data channel provided by a dedicated access network node post configuration. The mapping of a QoS flow to a data channel remains fixed throughout the lifetime of a PDU session. Thus, packets from a QoS flow cannot be distributed on 2 or more data channels, even if the data channels were available (and capable of fulfilling the QoS) regardless, if the data channels belong to the same access network node or belong to other access nodes in the same access network or to access nodes in different access networks, possibly with even different technologies. The major drawbacks of such fixed assignment include in-efficient resource utilization, limited throughput, and latency.

To overcome these drawbacks embodiments disclosed herein of the UE 110, the base station 120, and the network entity 130 illustrated in FIG. 1 support distribution of Service Data Flows (corresponding to QoS Flows in 5G) over multiple data channels offered by either a single access node or multiple access nodes regardless of their access technologies. As will be described in more detail in the following, the UE 110, the base station 120, and the network entity 130 are configured to make use of the mapping data structure 160, in particular mapping table 160 (herein referred to as Service data flow Distribution Table, SDT, 160) to capture SDF/QoS/Traffic profile (e.g., mmtc, uRLLC, etc.) mapping to available networks and their corresponding data channels e.g., provided by the operator. To this end, the UE 110, the base station 120, and the network entity 130 are configured to implement a respective Service data flow Distribution Manager (SDM) 111a, 121a, 131a for mapping the data packets from each SDF/QoS Flow to available network(s) and their corresponding data channels 118 by querying the SDT 160.

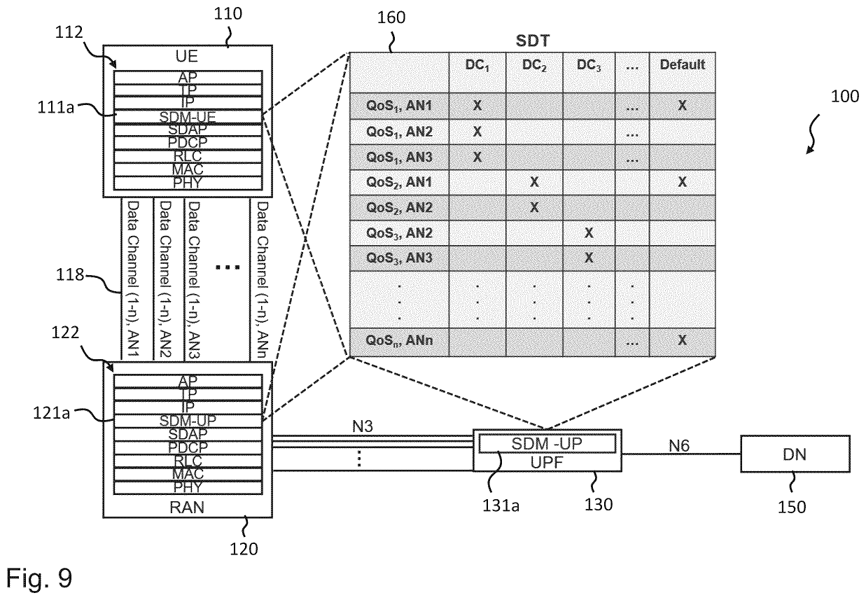

In an embodiment, the SDM 111a of the UE 110 may be implemented in a new layer-2 sublayer below the IP layer and above the SDAP sublayer in the 3GPP 5G (and beyond 5G) protocol stack 112, as shown in FIG. 9. In an embodiment, the SDM 111a of the UE 110 is configured to query the SDT 160 with QI and receives a list of ANs and their corresponding data channels 118 as the response. Moreover, the SDM 111a selects an AN and a corresponding data channel 118 and forwards the packet to the corresponding SDAP entity in the next sublayer of the protocol stack 112. As will be appreciated, there may be multiple SDAP entities in the SDAP layer of the UE protocol stack 112, namely one each for every connected network (currently a 3GPP standard for 5G). The SDAP layer of the protocol stack 112 forwards the packet to the selected AN over the selected data channel 118.

In an embodiment, the SDM 131a of the network entity 130 and the SDM 121a of the base station 120 may be located in a new layer-2 sublayer below the IP and above the MAC/Ethernet sublayer in Core UP and above the SDAP sublayer in the 3GPP 5G (and beyond 5G) protocol stack (as illustrated in FIG. 9 for the base station 120), respectively. The network entity 130, for instance UPF 130, and the base station 120 are configured to receive the SDT 160 from the core network e.g., from the SMF 140 via N4 during PDU session establishment, as illustrated in FIG. 2.

In an embodiment, the network entity 130, e.g. UPF 130 maintains multiple N3 tunnels with each AN node, including the base station 120, that is available for the PDU session (informed by the SMF 140 or derived from the SDT 160). In an embodiment, the network entity 130, e.g. UPF 130 is configured to receive QoS markings (QI) from the SMF 140, as currently defined by the 3GPP standard, and the SDM 131a of the network entity 130, e.g. UPF 130 uses the QI to query the SDT 160 and select an AN (if >1) for sending the packet. The base station 120 receives the packet and using the QI marking in the packet the SDM 121a of the base station 120 queries the SDT 160 and receives the data channel 118 on which to forward the packet to the UE 110. Then the base station 120 forwards the packet to the UE 110 over the selected data channel 118.

In an embodiment, the SDT 160 may be located, i.e. stored and used along with the SDM 111a, 121a, 131a in a new layer-2 sublayer below the IP layer and above the SDAP sublayer in the 3GPP 5G (and beyond 5G) protocol stack. In an embodiment, this sublayer is configured to implement a process for adding, modifying and/or deleting the content, i.e. the mapping data of the SDT 160 as per MNO (e.g., SMF) or OS command. Moreover, in an embodiment, this sublayer may implement a process for receiving and responding to queries from the SDM-UE/SDM-UP and MNO (e.g., SMF)/Operating System (OS), and the like.

In an embodiment, the SDT 160 may be populated either statically or dynamically. For statically populating the SDT 160 the values for the cells in the SDT 160, i.e. the mapping data can be provided by the Mobile Network Operator (MNO) upon the registration of the UE 110 based on the user profile and subscription information. For instance, as shown in FIG. 2, for an embodiment of the mobile telecommunication system 100 as a 3GPP 5G network 100, the SMF 140 in the core network may provide the mapping data to the UE 110 and the base station 120 via the AMF 141 and to the network entity 130, e.g. UPF 130 via the N4 interface based on the PCC rules provided by the PCF 145, subscription information available in the UDM 143 and data channel availability information from the base station 120. In a further embodiment for statically populating the SDT 160 the values for the cells, i.e. the mapping data may be hard coded in the UE 110 from the manufacturer or provided by the OS upon startup. For instance, presently, in the 4G and 5G UE's, Wi-Fi is prioritized over cellular connections by default.

For dynamically populating the SDT 160, in an embodiment, the values may be updated by the MNO dynamically based on internal policies, network conditions, traffic, and the like. For instance, as shown in FIG. 2, for an embodiment of the mobile telecommunication system 100 as a 3GPP 5G network 100, the SMF 140 in the core network may provide the inputs to the UE 110 and the base station 120 via the AMF 141 and to the network entity 130, e.g. UPF 130 via the N4 interface based on the PCC rules provided by the PCF 145, subscription information available in the UDM 143 and data channel availability information from the base station 120. In a further embodiment for dynamically populating the SDT 160 the values may be updated dynamically by the OS on the mobile, e.g., based on the applications that are running and the connected networks.

In an embodiment, the multi-access PDU connectivity service may be realized by establishing a multi-access PDU session (MA PDU), wherein the PDU session may have resources allocated on two or more access nodes, such as the base station 120, in the same or different access networks with the same or different access technologies. However, the following set of supporting features are provided by further embodiments in addition to the SDMs 111a, 121a, 131a and the SDT 160 to realize SDFs in the mobile telecommunication system 100 during data transmission.

For instance, in an embodiment the mobile telecommunication system 100 may comprise a core network entity like the Unified Data Management (UDM) 143 in 3GPP 5G systems (which usually contains mobile subscription information of users), wherein the core network entity includes multi-connectivity/multi-access as a subscribed feature for users.

In an embodiment, the mobile telecommunication system 100 may comprise a further core network entity like the Policy Control Function (PCF) 145 in 3GPP 5G systems (which usually provides policies for traffic flows), wherein the further core network entity is configured to provide policies related to multi-connectivity/multi-access for each user.

In an embodiment, the mobile telecommunication system 100 may comprise a further core network entity like the Session Management Function (SMF) 140 in 3GPP 5G systems (which usually handles the creation/update/deletion of user sessions like a PDU session), wherein the further core network entity is configured to retrieve the subscriber information related to multi-connectivity from the UDM 143 and corresponding policies for multi-connectivity from the PCF 145 and the data channel availability information across connected access nodes, such as the base station 120. Moreover, the further core network entity may be configured to generate the necessary rules/instruction/inputs for the SDT 160 and the SDMs 111a, 121, 131a and send them to the UE 110, the base station 120 and the UPF 130 via NAS protocol and, N11 and N4 interface exchanges during PDU session establishment request, as illustrated in FIG. 2.

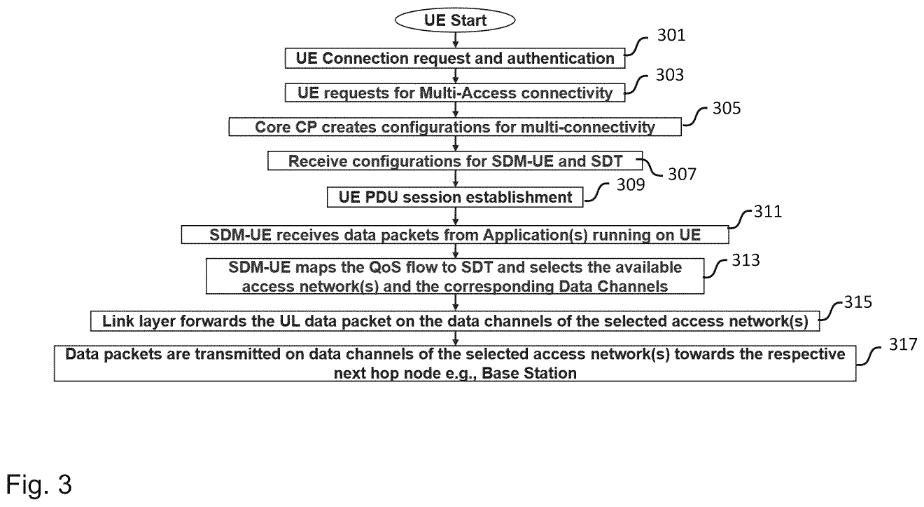

FIG. 3 is a flow diagram illustrating processing steps implement by the UE 110 according to an embodiment for UL multi-connectivity data transmission based on the SDT 160. In a first step 301 of FIG. 3, the UE 110 issues a connection request and performs authentication. In a step 303 the UE 110 requests for Multi-Access connectivity. In a step 305, the core network CP entity 140 creates the configurations for multi-connectivity. In a step 307, the UE 110 receives the configurations for the SDM 111a of the UE 110 and the SDT 160. In a step 309, the UE 110 establishes a PDU session. In a step 311, the SDM 111a implemented by the UE 110 receives data packets from one or more applications running on the UE 110. In a step 313 the SDM 111a implemented by the UE 110 maps the QoS flow, i.e. SDF to the SDT 160 and selects the available access network(s) and the corresponding data channels 118. In a step 315 the link layer of the UE 110 forwards the UL data packet on the data channels 118 of the selected access network(s). In a step 317 the data packets are transmitted on the data channels 118 of the selected access network(s) towards the respective next hop node, in particular the base station 120.

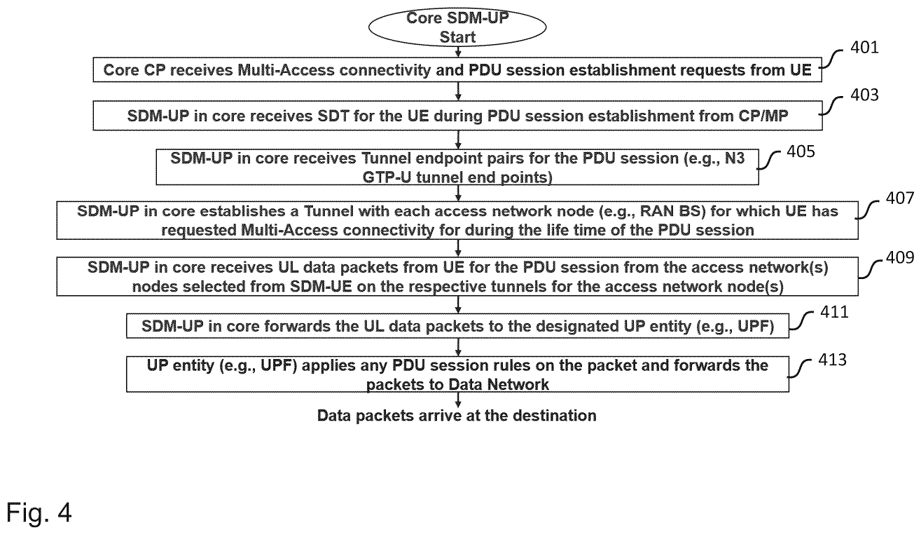

FIG. 4 is a flow diagram illustrating processing steps implement by the network entity 130, e.g. UPF 130 according to an embodiment for UL multi-connectivity data transmission based on the SDT 160. In a first step 401 of FIG. 4 the core network CP entity 140 receives a Multi-Access connectivity request and a PDU session establishment request from the UE 110. In a step 403 the SDM 131a of the network entity 130 in the core network receives the SDT 160 for the UE 110 during the establishment of the PDU session from CP/MP. In a step 405 the SDM 131a of the network entity 130 in the core network further receives tunnel endpoint pairs for the PDU session (e.g., N3 GTP-U tunnel end points). In a step 407 the SDM 131a of the network entity 130 in the core network establishes a tunnel with each access network node (e.g., the RAN base station 120) for which the UE 110 has requested Multi-Access connectivity for the lifetime of the PDU session. In a step 409 the SDM 131a of the network entity 130 in the core network receives UL data packets from the UE 110 for the PDU session from the access network(s) nodes, for instance the base station 120, selected by the SDM 111a of the UE 110 on the respective tunnels for the access network node(s). In a step 411 the SDM 131a of the network entity 130 in the core network forwards the UL data packets to the designated UP entity (e.g., UPF). In a step 411 the designated UP entity (e.g., UPF) applies any PDU session rules on the packet and forwards the packets to the data network 150.

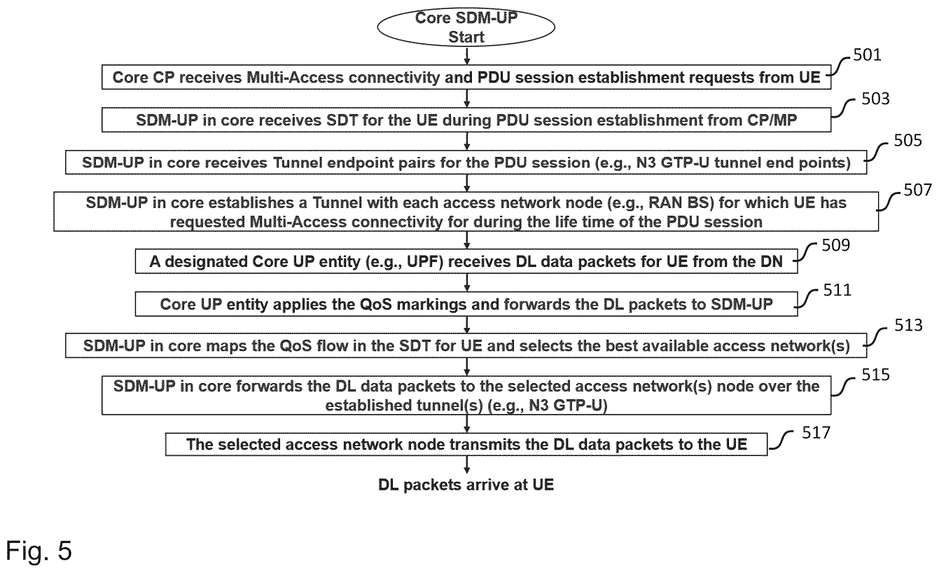

FIG. 5 is a flow diagram illustrating processing steps implement by the network entity 130 according to an embodiment for DL multi-connectivity data transmission based on the SDT 160. In a first step 501 of FIG. 5 the CP entity 140 of the core network receives a Multi-Access connectivity request and a PDU session establishment request from the UE 110. In a step 503 the SDM-UP entity 130 in the core network receives the SDT 160 for the UE 110 during PDU session establishment from CP/MP. In a step 505 the SDM-UP entity 130 in the core network receives tunnel endpoint pairs for the PDU session (e.g., N3 GTP-U tunnel end points). In a step 507 the SDM-UP entity 130 in the core network establishes a tunnel with each access network node, for instance, the base station 120, for which the UE 110 has requested Multi-Access connectivity for the lifetime of the PDU session. In a step 509 a designated core network UP entity 130, such as a UPF 130, receives DL data packets for the UE 110 from the DN 150. In a step 511 the UP entity 130 of the core network applies the QoS, i.e. SDF markings and forwards the DL packets to the SDM-UP 130. In a step 513 the SDM-UP 130 in the core network maps the QoS, i.e. SDF flow in the SDT 115a for the UE 110 and selects the best available access network(s). In a step 515 the SDM-UP 130 in the core network forwards the DL data packets to the selected access network(s) node, for instance, the base station 120 over the established tunnel(s) (e.g., N3 GTP-U). In a step 517 the selected access network node, for instance, the base station 120 transmits the DL data packets to the UE 110.

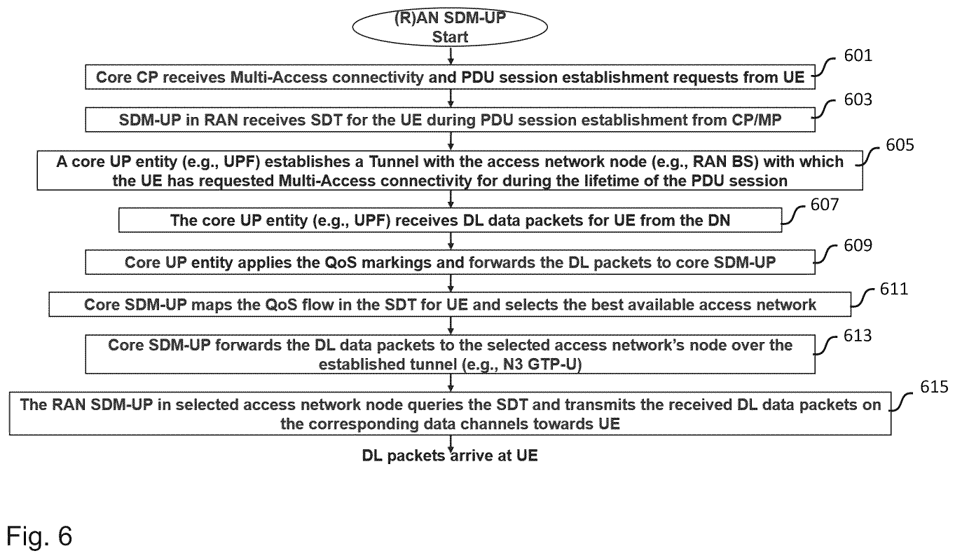

FIG. 6 is a flow diagram illustrating processing steps implement by the base station according to an embodiment for DL multi-connectivity data transmission based on the SDT 160. In a step 601 of FIG. 6 the core network CP entity 140 receives a Multi-Access connectivity request and a PDU session establishment request from the UE 110. In a step 603 the SDM 121 of the base station 120 receives the SDT 160 for the UE 110 during PDU session establishment from CP/MP. In a step 605 the core network UP entity 130 (e.g., a UPF 130) establishes a tunnel with the access network node (e.g., the base station 120) with which the UE 110 has requested Multi-Access connectivity for during the lifetime of the PDU session. In a step 607 the core network UP entity 130 (e.g., UPF 130) receives DL data packets for the UE 110 from the DN 150. In a step 609 the core network UP entity 130 applies the QoS, i.e. SDF markings and forwards the DL packets to the core network SDM 131a. In a step 611 the core network SDM 131a maps the QoS flow, i.e. SDF in the SDT 160 for the UE 110 and selects the best available access network. In a step 613 the core network SDM 131a forwards the DL data packets to the selected access network's node, such as the base station 120, over the established tunnel (e.g., N3 GTP-U). In a step 615 the SDM 121a of the base station 120 queries the SDT 160 and transmits the received DL data packets on the corresponding data channels 118 towards the UE 110.

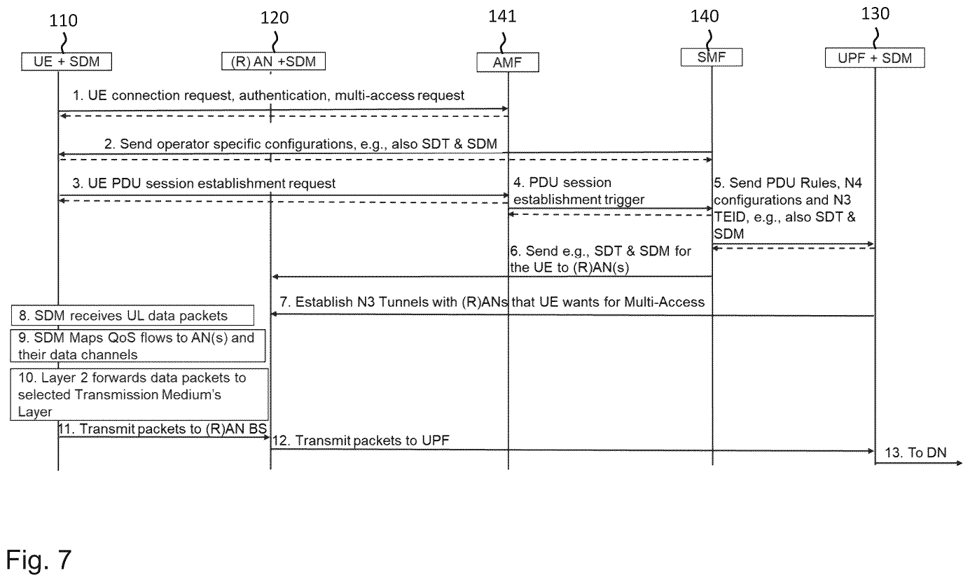

FIG. 7 is a signaling diagram illustrating interactions between the UE 110, the base station 120, and the network entity 130 according to an embodiment with further network entities for UL multi-connectivity data packet transmission. In a step 1 in FIG. 7 the UE 110 sends a connection request, authentication and multi-access request to the AMF 141. In a step 2 in FIG. 7 the SMF 140 sends operator specific configurations to the UE 110, including the SDT 160 (and if not yet available the SDM 131a). In a step 3 of FIG. 7 the UE 110 sends a PDU session establishment request to the AMF 141. In response thereto, in a step 4 of FIG. 7 the AMF 141 issues a PDU session establishment trigger to the SMF 140. In turn, the SMF 140 in a step 5 of FIG. 7 sends different configuration data to the network entity 130, e.g. UPF 130, such as PDU rules, N4 configurations, N3 TEID, and/or the SDT 160 (and if not yet available the SDM 131a). In a step 6 of FIG. 7 the SMF 140 sends the SDT 160 (and if not yet available the SDM 121a) to the access network(s), such as the base station 120. In a step 7 of FIG. 7 the network entity 130, e.g. UPF 130 establishes N3 tunnels with the access network(s), such as the base station 120, the UE 110 wants to use for multi-access. In a step 8 of FIG. 7 the SDM 111a of the UE 110 receives UL data packets, for instance, from one or more applications running on the UE 110. In a step 9 of FIG. 7 the SDM 111a of the UE 110 maps QoS/SDF flows to the access networks and their data channels 118, as already described above. In a step 10 of FIG. 7 the second layer of the protocol stack 112 of the UE 110 forwards these packets to the selected transmission medium's layer. In a step 11 of FIG. 7 the UE 111 transmits resulting packets to the access network node(s), such as the base station 120. In a step 12 of FIG. 7 the access network node(s), such as the base station 120, forward these packets to the network entity 130, e.g. UPF 130.

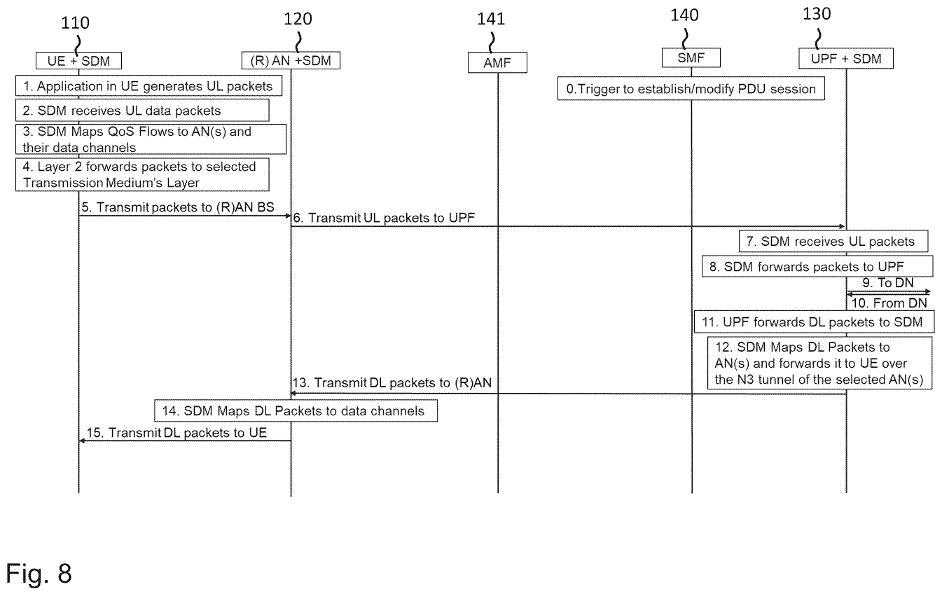

FIG. 8 is a signaling diagram illustrating interactions between the UE 110, the base station 120, and the network entity 130 according to an embodiment with further network entities for DL multi-connectivity data packet transmission. In a step 0 in FIG. 8 the SMF 140 is triggered to establish or modify a PDU session. In a step 1 of FIG. 8 an application running on the UE 110 generates UL data packets. In a step 2 of FIG. 8 the SDM 111a of the UE 110 receives the UL data packets. In a step 3 of FIG. 8 the SDM 111a of the UE 110 maps QoS/SDF flows to the access networks and their data channels 118, as already described above. In a step 4 of FIG. 8 the second layer of the protocol stack 112 of the UE 110 forwards the packets to the selected transmission medium's layer. In a step 5 of FIG. 8 the UE 110 transmits resulting packets to the access network node(s), such as the base station 120. In a step 6 of FIG. 8 the access network node(s), such as the base station 120, forwards these packets to the network entity 130, e.g. UPF 130. In a step 7 of FIG. 8 the SDM 131a of the UPF 130 receives the UL data packets. In a step 8 of FIG. 8 the SDM 131a forwards the packets to the UPF 130. In a step 9 of FIG. 8 the UPF 130 forwards the UL data packets to the data network 150, which, in turn, responds with one or more DL data packets in a step 10 of FIG. 8. In a step 11 of FIG. 8 the UPF 130 forwards the DL data packets to the SDM 131a. In a step 12 of FIG. 8 the SDM 131a maps the DL packets to the access network(s) based on the SDT 160 in the way described above and forwards these over the N3 tunnel to the selected access network(s). In a step 13 of FIG. 8 the UPF 130 transmits the DL data packets to the corresponding access network node(s), such as the base station 120. In a step 14 of FIG. 8 the base station 120 maps the DL packets to data channels 118 based on the SDT 160 in the way described above. In a step 15 of FIG. 8 the base station 120 transmits the DL packets to the UE 110 via the selected data channels 118.

FIGS. 9 to 11 show schematic diagrams illustrating different variants of the mobile telecommunication system 110 of FIG. 1 comprising the UE 110, the base station 120, and the network entity 130 according to an embodiment making use of the SDT 160 for establishing multi-connectivity communication with the data network 150, e.g. the Internet 150.

In the embodiment shown in FIG. 9 the SDM 111a of the UE 110 is implemented below the IP layer and above the SDAP layer of the UE protocol stack 112, as already described above. Likewise, the SDM 121a of the base station 120 is implemented below the IP layer and above the SDAP layer of the BS protocol stack 122.

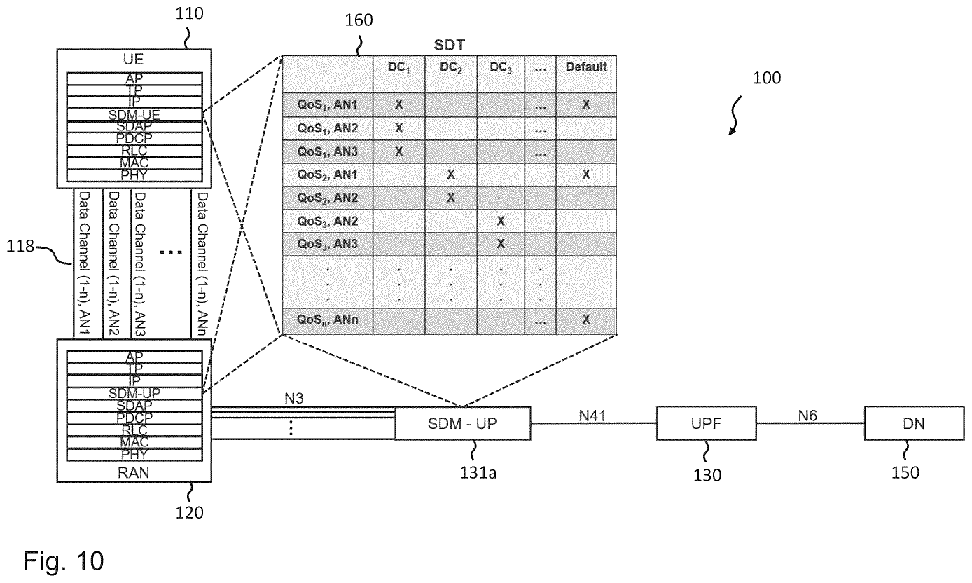

In the embodiment shown in FIG. 10 the SDM 131a and the network entity 130, e.g. UPF 130 may be connected via an interface (herein referred to as N41 interface). The N41 interface allows hiding the complexities of connecting and managing multiple N3 tunnels with multiple different types of ANs from the core UP entity, such as the UPF 130. Moreover, the N41 interface enables the Core UP entity, e.g. the UPF 130 to connect to the SDM 131a in the core similar to a N3 connection between the UPF 130 and a BS in RAN in a 3GPP 5G system.

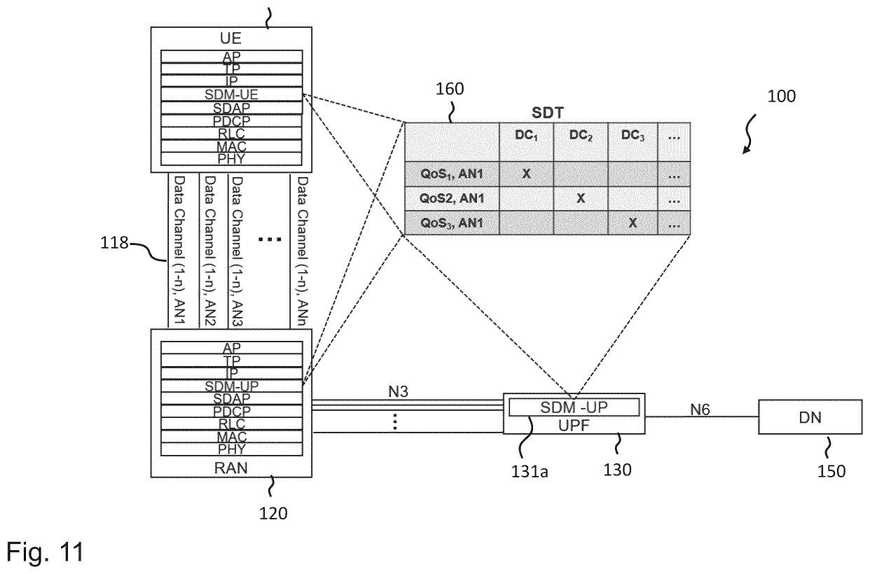

The embodiment shown in FIG. 11 illustrates the backward compatibility of the SDMs 111a, 121a, 131a and the SDT 140 with conventional 3GPP communication.

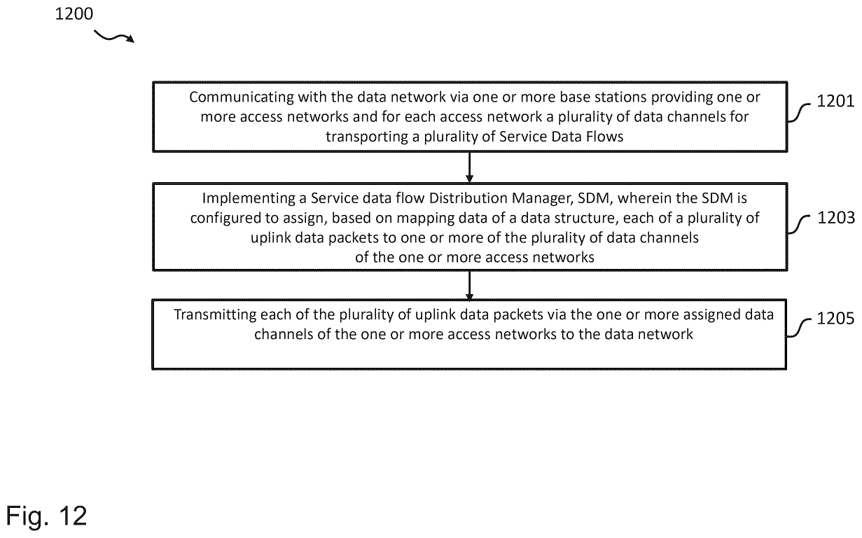

FIG. 12 is a flow diagram illustrating a method 1200 for operating a user equipment, UE, such as the UE 110 of FIG. 1, for communication with a data network 150. The method 1200 comprises a step 120a of communicating with the data network 150 via one or more base stations 120 providing one or more access networks and for each access network a plurality of data channels 118 for transporting a plurality of Service Data Flows, SDFs. Moreover, the method 1200 comprises a step 1203 of implementing a Service data flow Distribution Manager, SDM, 111a, wherein the SDM 111a is configured to assign, based on mapping data of a data structure 160, each of a plurality of uplink data packets to one or more of the plurality of data channels 118 of the one or more access networks. The method 1200 further comprises a step 1205 of transmitting each of the plurality of uplink data packets via the one or more assigned data channels 118 of the one or more access networks to the data network 150.

The method 1200 can be performed by the UE 110 according to an embodiment. Thus, further features of the method 1200 result directly from the functionality of the UE 110 as well as the different embodiments thereof described above and below.

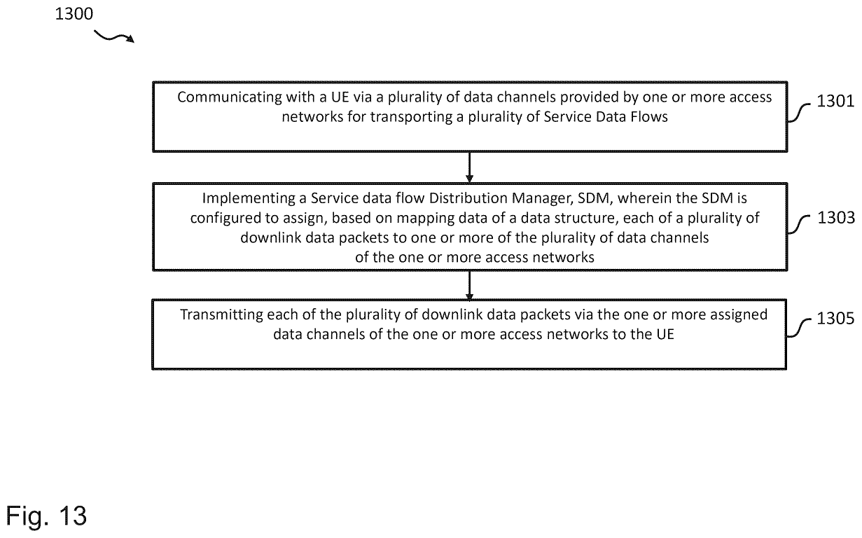

FIG. 13 is a flow diagram illustrating a method 1300 for operating a base station, such as the base station 120 of FIG. 1, for handling communication between a user equipment, UE, 110 and a data network 150. The method 1300 comprises a step 1301 of communicating with the UE 110 via a plurality of data channels 118 provided by one or more access networks for transporting a plurality of Service Data Flows, SDFs. Moreover, the method 1300 comprises a step 1303 of implementing a Service data flow Distribution Manager, SDM, 121a, wherein the SDM 121a is configured to assign, based on mapping data of a data structure 160, each of a plurality of downlink data packets to one or more of the plurality of data channels 118 of the one or more access networks. The method 1300 further comprises a step 1305 of transmitting each of the plurality of downlink data packets via the one or more assigned data channels 118 of the one or more access networks to the UE 110.

The method 1300 can be performed by the base station 110 according to an embodiment. Thus, further features of the method 1300 result directly from the functionality of the base station 120 as well as the different embodiments thereof described above and below.

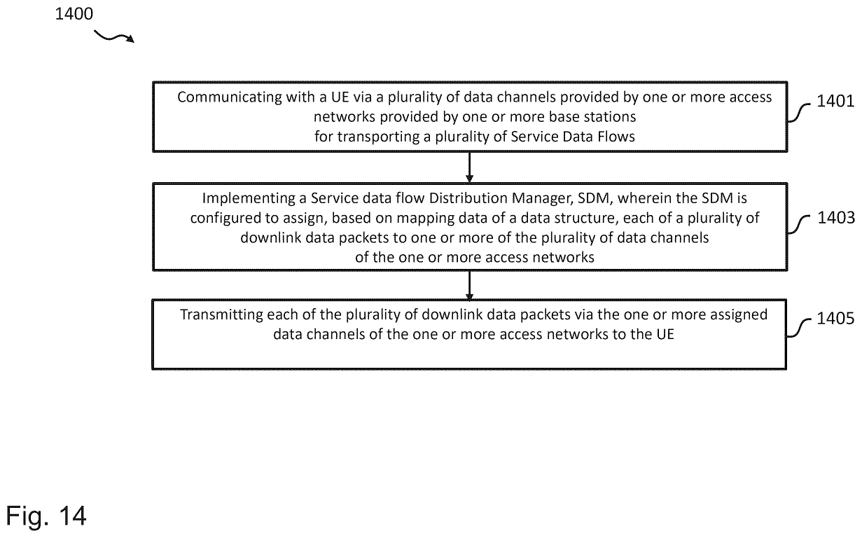

FIG. 14 is a flow diagram illustrating a method 1400 for operating a network entity, such as the network entity 130, in particular UPF of FIG. 1, for handling communication between a user equipment, UE, 110 and a data network 150. The method 1400 comprises a step 1401 of communicating with the UE 110 via a plurality of data channels 118 provided by one or more access networks provided by one or more base stations 120 for transporting a plurality of Service Data Flows, SDFs. Moreover, the method 1400 comprises a step 1403 of implementing a Service data flow Distribution Manager, SDM, 131a, wherein the SDM 131a is configured to assign, based on mapping data of a data structure 160, each of a plurality of downlink data packets to one or more of the plurality of data channels 118 of the one or more access networks. Moreover, the method 1400 comprises a step 1405 of transmitting each of the plurality of downlink data packets via the one or more assigned data channels 118 of the one or more access networks to the UE 110.

The method 1400 can be performed by the network entity 130 according to an embodiment. Thus, further features of the method 1400 result directly from the functionality of the network entity 130 as well as the different embodiments thereof described above and below.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely a logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the disclosure may be integrated into one processing unit, or each of the units may exist alone physically, or two or more units may be integrated into one unit.

What is claimed is:

1. A user equipment (UE) (110), comprising:
a transceiver; and
at least one processor coupled to one or more memories storing programming instructions, wherein the programming instructions are executed by the at least one processor to cause the first apparatus to perform operations comprising:
communicating with the data network (150) via one or more base stations (120) providing one or more access networks and for each access network a plurality of data channels (118) for a plurality of Service Data Flows (SDFs);
storing a data structure (160) containing mapping data;
implementing a Service data flow Distribution Manager (SDM) (111a), wherein the SDM (111a) is configured to assign, based on the mapping data of the data structure (160), each of a plurality of uplink data packets to one or more of the plurality of data channels (118) of the one or more access networks; and
transmitting each of the plurality of uplink data packets via the one or more assigned data channels (118) of the one or more access networks to the data network (150).

2. The UE (110) according to claim 1, wherein each uplink data packet of the plurality of uplink data packets comprises a SDF identifier and wherein the SDM (111a) is configured to assign each of the plurality of uplink data packets to the one or more of the plurality of data channels (118) of the one or more access networks, based on the mapping data of the data structure (160) and the SDF identifier of the uplink data packet.

3. The UE (110) according to claim 1, wherein the data structure (160) is a Service data flow Distribution Table (SDT) (160) comprising the mapping data.

4. The UE (110) according to claim 1, wherein the plurality of uplink data packets are part of a PDU session.

5. The UE (110) according to claim 1, wherein the programming instructions are executed by the at least one processor to cause the UE to further perform operations comprising:
implementing a protocol stack (112) and to implement the SDM (111a) in a layer of the protocol stack (112) above a Service Data Adaptation Protocol (SDAP) layer of the protocol stack (112) or below an IP layer.

6. The UE (110) according to claim 1, wherein the programming instructions are executed by the at least one processor to cause the UE to further perform operations comprising:
implementing a protocol stack (112) and to implement the SDM (111a) in a layer of the protocol stack (112) above a Service Data Adaptation Protocol (SDAP) layer of the protocol stack (112) and below an IP layer.

7. The UE (110) according to claim 1, wherein the programming instructions are executed by the at least one processor to cause the UE to further perform operations comprising:
receiving the data structure (160) with the mapping data from a control plane entity (140).

8. A method (1200) for communication, wherein the method (1200) comprises:
communicating (1201) with the data network (150) via one or more base stations (120) providing one or more access networks and for each access network a plurality of data channels (118) for transporting a plurality of Service Data Flows (SDFs);
implementing (1203) a Service data flow Distribution Manager (SDM) (111a), wherein the SDM (111a) is configured to assign, based on mapping data of a data structure (160), each of a plurality of uplink data packets to one or more of the plurality of data channels (118) of the one or more access networks; and
transmitting (1205) each of the plurality of uplink data packets via the one or more assigned data channels (118) of the one or more access networks to the data network (150).

9. The method (1200) according to claim 8, wherein each uplink data packet of the plurality of uplink data packets comprises a SDF identifier and wherein the SDM (111a) is configured to assign each of the plurality of uplink data packets to the one or more of the plurality of data channels (118) of the one or more access networks, based on the mapping data of the data structure (160) and the SDF identifier of the uplink data packet.

10. The method (1200) according to claim 8, wherein the data structure (160) is a Service data flow Distribution Table (SDT) (160) comprising the mapping data.

11. The method (1200) according to claim 8, wherein the plurality of uplink data packets are part of a PDU session.

12. The method (1200) according to claim 8, wherein the method further comprises:
implementing a protocol stack (112) and to implement the SDM (111a) in a layer of the protocol stack (112) above a Service Data Adaptation Protocol (SDAP) layer of the protocol stack (112) or below an IP layer.

13. The method (1200) according to claim 8, wherein the method further comprises:
implementing a protocol stack (112) and to implement the SDM (111a) in a layer of the protocol stack (112) above a Service Data Adaptation Protocol (SDAP) layer of the protocol stack (112) and below an IP layer.

14. The method (1200) according to claim 8, wherein the method further comprises:
receiving the data structure (160) with the mapping data from a control plane entity (140).

15. A method (1300) for communication, wherein the method (1300) comprises:
communicating (1301) with a user equipment (UE) (110) via a plurality of data channels (118) provided by one or more access networks for transporting a plurality of Service Data Flows (SDFs);
implementing (1303) a Service data flow Distribution Manager (SDM) (121a), wherein the SDM (121a) is configured to assign, based on mapping data of a data structure (160), each of a plurality of downlink data packets to one or more of the plurality of data channels (118) of the one or more access networks; and
transmitting (1305) each of the plurality of downlink data packets via the one or more assigned data channels (118) of the one or more access networks to the UE (110).

16. The method (1300) according to claim 15, wherein each downlink data packet of the plurality of downlink data packets comprises a SDF identifier and wherein the SDM (121a) is configured to assign each of the plurality of downlink data packets to the one or more of the plurality of data channels (118) of the one or more access networks, based on the mapping data of the data structure (160) and the SDF identifier of the downlink data packet.

17. The method (1300) according to claim 15, wherein the data structure (160) is a Service data flow Distribution Table (SDT) (160) with the mapping data.

18. The method (1300) according to claim 15, wherein the plurality of downlink data packets are part of a PDU session.

19. The method (1300) according to claim 15, wherein the method (1300) further comprises:
implementing a protocol stack (122) and to implement the SDM (121a) in a layer of the protocol stack (122) above a Service Data Adaptation Protocol, SDAP, layer of the protocol stack (122) or below an IP layer.

20. The method (1300) according to claim 15, wherein the method (1300) further comprises:
receiving the data structure (160) with the mapping data from a control plane entity (140).
